(19) United States
(12) Patent Application Publication
(10) Pub. No.: US 2003/0099253 A1
(43) Pub. Date: May 29, 2003

(54) Apparatus and method for arbitrating data transmission amongst devices having SMII standard

(75) Inventor: Mee Sun Kim, Seoul (KR)

Correspondence Address: BRUCE E. LILLING, LILLING & LILLING P.C., P.O. BOX 560, GOLDEN BRIDGE, NY, 10526, US

(73) Assignee: Corecess Inc., Seoul (KR)

(21) Appl. No.: 10/058,431

(22) Filed: Jan. 28, 2002

(30) Foreign Application Priority Data
Nov. 28, 2001 (KR) 2001-74654

(51) Int. Cl. H04J 3/02

(52) U.S. Cl. 370/462; 370/461; 370/466

(57) ABSTRACT

Disclosed relates to an apparatus and method for arbitrating data transmission amongst at least a Media Access Control (MAC) device and at least a Physical Layer (PHY) device having a Serial Media Independent Interface (SMII), respectively, which can remove a restriction of a distance between the MAC and PHY devices on a printed circuit board (PCB) and prevent a transmission error due to a data transmission delay.

The apparatus for arbitrating data transmission amongst a first and a second devices corresponding to the MAC and PHY devices having SMII standard, respectively, the apparatus comprising at least one buffering means for buffering transmission data input from the first device to be resynchronized a predetermined number of times in a unit of a segment and outputting the resynchronized transmission data to the second device.

### BACKGROUND OF THE INVENTION

1. Field of the Invention

This invention relates in general to an apparatus for arbitrating data transmission amongst devices applied to an Ethernet switching system, and more particularly to an apparatus and method for arbitrating data transmission amongst at least a Media Access Control (MAC) device and at least a Physical Layer (PHY) device having a Serial Media Independent Interface (SMII), respectively, which can remove a restriction of a distance amongst the MAC and PHY devices on a printed circuit board (PCB) and prevent a transmission error due to a data transmission delay.

2. Description of the Related Art

In general, an Ethernet switching system, such as an Ethernet switch comprised the Media Access Control (MAC) device having a MAC protocol for executing a switching operation and the Physical Layer (PHY) device having a PHY protocol for executing a connecting operation to a physical layer, such as the Ethernet, in transmitting and receiving data through the Ethernet.

An interface amongst the MAC and PHY devices governed by the Institute Electrical and Electronics Engineers (IEEE) 802.3U includes a Media Independent Interface (MII), a Reduced Media Independent Interface (RMII), SMII, and so on. The SMII standard dedicated to a multi-port is defined as clocks and synchronization signals are supplied to the MAC and PHY devices unidirectionally in order to reduce the number of signals processed in the switching system.

Accordingly, where the data transmission is performed amongst one MAC device and plural PHY devices connected therewith based on the SMII standard, there is a need to put a restriction on the distance of PCB pattern amongst those devices, which has drawbacks in designing the PCB pattern, and causes an error in transmitting data if the PCB pattern is designed in excess of the distance permitted.

Hereinafter, why the distance of PCB pattern amongst the MAC and PHY devices is restricted will be explained.

Table 1 shows input and output paths of synchronization signal (SYNC) and transmitting/receiving data (TX/RX) based on the SMII.

TABLE 1

| Signal | Output | Input |
|---|---|---|
| RX | PHY | MAC |
| Tx | MAC | PHY |
| SYNC | MAC | PHY |
| CLK | System or MAC | MAC and PHY |

The SMII standard provides two data signals (Tx/Rx), a synchronization signal (SYNC) and a clock (CLK) per a port. Here, it is defined to use either a system clock or a clock of the MAC device.

As shown in table 1, when the synchronization signal SYNC is transmitted from the MAC device to the PHY device, prior to data transmission and reception, data to be received from Ethernet are forwarded to the MAC device through the PHY device and data to be transmitted to Ethernet are sent to the PHY device through the MAC device.

Table 2 illustrates times required when transmitting and receiving data of one clock according to the SMII standard. The clocks CLK are supplied both to the MAC and PHY devices based on 125 MHz (one clock period: 8 ns).

TABLE 2

| | Minimum | Maximum |
|---|---|---|
| Input Setup Time (ns) | 1.5 | — |
| Input Hold Time (ns) | 1 | — |
| Output Delay Time (ns) | 2 | 5 |

As shown in FIG. 2, to transmit data accurately, there are required a data input setup time (T1) and a data input hold time (T2). That is, as shown in Table 2, the minimum input setup time requires 1.5 ns, the minimum input hold time requires 1 ns and the output delay time between the MAC and PHY devices requires 2 to 5 ns.

A data transmission delay time between the MAC and PHY devices when receiving data from Ethernet can be calculated with reference to Table 2 as follows:

1. When the synchronization signal SYNC of the MAC device is received into the PHY device, input setup time (SYNC)+input hold time (SYNC)=1.5 ns+1 ns=2.5 ns;

2. When the received data (Rx) of the PHY device is transmitted to the MAC device according to the synchronization signal input,

input setup time (Rx data)+input hold time (Rx data)=1.5 ns+1 ns=2.5 ns; and

3. When the minimum output delay time 2 ns in Table 2 is added to the above two times of 1 and 2,

the minimum data transmission delay time=2.5 ns+2.5 ns+2 ns=7 ns.

Here, it can be learned that since the one clock period based on 125 MHz is 8 ns, a margin of the data transmission delay time which doesn't commit an error in transmitting data between the MAC and PHY devices is less than 1 ns.

Accordingly, the length of PCB pattern between the MAC and PHY devices in consideration of the margin of the data transmission delay time will be calculated hereinafter. As a test result of the inventor of the application, it was noted that the data transmission delay time for 1 meter, the length of PCB pattern between the MAC and PHY devices, is 7.45 ns. That is, the length of PCB pattern (L) permitted per 1 ns is set forth with a following proportional expression;

7.45 ns: 1 m=1 ns: L,

L≈0.134 m

Consequently, the permissible length of PCB pattern between the MAC and PHY devices is less than 13.4 cm. If the length of PCB pattern between the MAC and PHY devices is designed in excess of 13.4 cm, the respective data bits transmitted to the MAC and PHY devices based on the clocks supplied at the period of 8 ns are not recognized by the MAC and PHY devices due to the transmission delays, thus causing an error in transmitting data. This will be applied the same way to the process of transmitting data to Ethernet.

Accordingly, it is necessary that the length (L) of PCB pattern between the MAC and PHY devices 10 and 20 having the conventional SMII standard be restricted less than 13.4 cm as shown in FIG. 1. Besides, where plural PHY devices 20 are connected to one MAC device 10 to accommodate plural ports, the respective lengths of PCB pattern amongst the MAC device 10 and the plural PHY devices 20 should meet the restriction of 13.4 cm, which makes it difficult to design PCB pattern.

### BRIEF SUMMARY OF THE INVENTION

Accordingly, it is an object of the present invention to provide an apparatus for arbitrating data transmission between a first and a second devices corresponding to a media access control (MAC) device and a physical layer (PHY) device having a serial media independent interface (SMII), respectively, the apparatus comprising at least one buffering means for buffering transmission data input from the first device to be resynchronized a predetermined number of times in a unit of a segment and outputting the resynchronized transmission data to the second device.

It is a further object of the present invention to provide an apparatus for arbitrating data transmission between devices having SMII standard further comprising at least one clock phase selecting means, connected to a clock input end of the buffering means, for varying phases of clocks input in predetermined ratios and supplying the varied clocks to the clock input end.

Another object of the present invention is to provide an apparatus for arbitrating data transmission between devices having SMII standard further comprising at least one switching means, positioned between output ends of the buffering means and the second device, for switching output paths of the buffering means and sending the transmission data, output from the output end of the buffering means with delayed for a predetermined number of clocks, to the second device.

An additional object of the present invention is to provide an apparatus for arbitrating data transmission between MAC and PHY devices having SMII standard comprising: a first buffer for buffering receiving data, input from the PHY device in a unit of a segment, to be resynchronized a predetermined number of times and outputting the resynchronized receiving data to the MAC device; a second buffer for buffering transmitting data, input from the MAC device in a unit of a segment, to be resynchronized a predetermined number of times and outputting the resynchronized transmitting data to the PHY device; and a third buffer for buffering synchronization signals, input from the MAC device every segment, to be resynchronized a predetermined number of times and outputting the resynchronized synchronization signals to the PHY device.

Yet another object of the present invention is to provide an apparatus for arbitrating data transmission between MAC and PHY devices having SMII standard, the first to third buffers including a plurality of output ends for outputting transmitting/receiving data and synchronization signals, respectively, with delayed for a predetermined number of clocks, the apparatus further comprising; a first clock switch for switching output paths of the first buffer and forwarding receiving data, output from the output end of the first buffer, to the MAC device; a second clock switch for switching output paths of the second buffer and forwarding transmitting data, output from the output end of the second buffer, to the PHY device; and a third clock switch for switching output paths of the third buffer and forwarding synchronization signals, output from the output end of the third buffer, to the PHY device.

Yet another object of the present invention is to provide an apparatus for arbitrating data transmission between MAC and PHY devices having SMII standard further comprising at least one clock phase selector, connected to each clock input end of the first to third buffers selectively, for varying phases of clocks input in predetermined ratios and supplying the varied clocks to the clock input end.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention:

In the drawings:

FIG. 1 is a conceptional view for illustrating a restriction of length of PCB pattern between a MAC device and a PHY device having a conventional SMII standard;

FIG. 2 illustrates an input setup time and an input hold time for data transmission;

FIG. 3 a block diagram for explaining a concept of an apparatus 30 for arbitrating data transmission amongst devices having a SMII standard in accordance with an embodiment of the invention;

FIG. 4 is a block diagram showing an internal configuration of the apparatus 30 for arbitrating data transmission in FIG. 3;

FIGS. 5a and 5b show how system clocks CLKs, synchronization signals SYNCs and transmitting/receiving data Tx/Rx are supplied to the apparatus 30 for arbitrating data transmission;

FIGS. 6 and 7 are flowcharts for illustrating the operations in accordance with the another embodiment of the invention; and

FIG. 8 is a timing diagram for showing an example of transmission delay between synchronization signals SYNCs and transmitting/receiving data Tx/Rx.

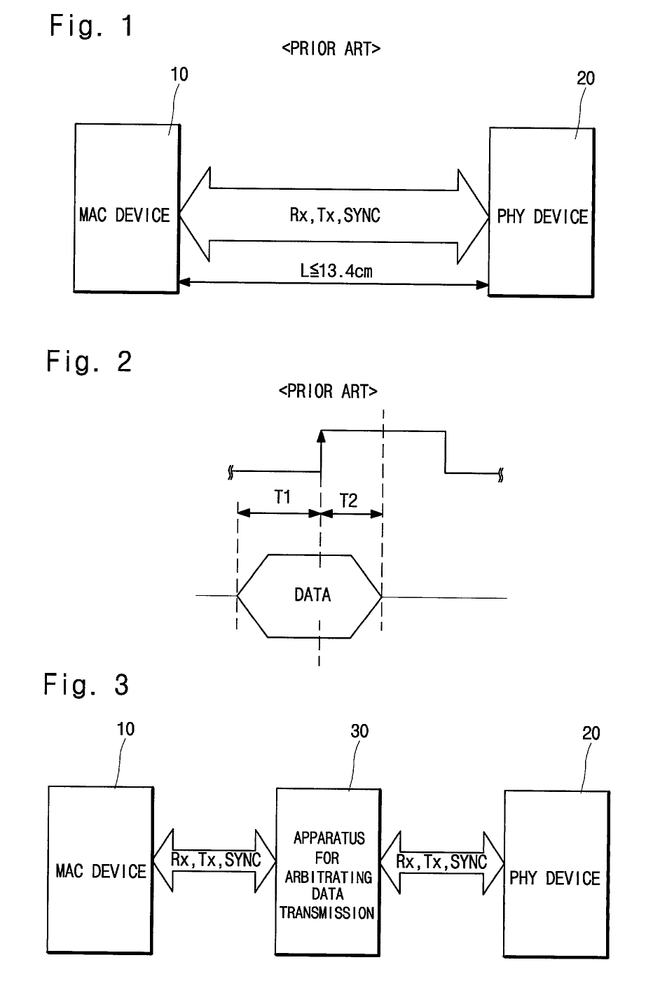

### DETAILED DESCRIPTION OF THE INVENTION

Reference will now be made in detail to the preferred embodiments of the present invention, examples of which are illustrated in the accompanying drawings.

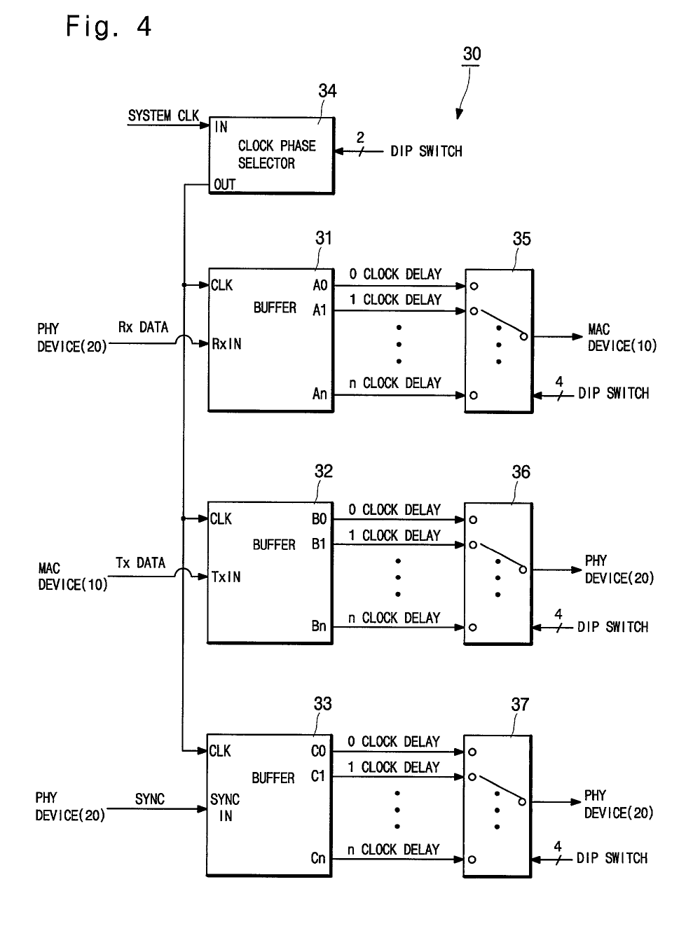

Referring now to FIG. 3, an apparatus 30 according to the invention for arbitrating data transmission connected between a MAC device 10 and a PHY device 20 executes an arbitration process of data transmission between the devices 10 and 20 by buffering transmission data between the MAC and PHY devices 10 and 20 to be resynchronized in a unit of a segment of having predetermined number of clocks. The process of buffering for preventing the data transmission delay caused by a restriction on length of PCB pattern between the MAC and PHY devices 10 and 20 resynchronizes the transmitting/receiving data Tx/Rx.

In an embodiment of the invention, the transmission data of one segment comprises a synchronization signal SYNC and transmitting/receiving data Tx/Rx of ten clocks CLKs, for example. The process of resynchronization achieved by the process of buffering is made once to ten times in consideration of characteristics of the PCB applied to, such as the length of PCB pattern influencing the data transmission delay, the width of PCB pattern, etc.

Accordingly, the apparatus 30 arbitrating the data transmission process in the unit of one segment doesn't cause an error in transmitting data of the respective clocks, but delays the arrival time of all transmission data slightly. That is, the apparatus 30 buffering and transmitting the data of the respective clocks to the corresponding device 10 or 20 is not affected by the 1 ns margin of the data transmission delay time, described above in detail, thus preventing the data transmission error caused by the restriction of the length of PCB pattern when transmitting data between the conventional MAC and PHY devices.

Hereinafter, referring to FIG. 4, a block diagram showing an internal configuration of the apparatus 30 for arbitrating data transmission in FIG. 3, the embodiment of the invention will be described in detail.

In the apparatus 30 in FIG. 4, the system clock is used as the clock CLK, whereas, the clock of the MAC device may be applied to. The apparatus 30 comprises a first, a second and a third buffers 31, 32 and 33, a clock phase selector 34, and a first, a second and a third clock switches 35, 36 and 37. The apparatus 30 is provided by a Complex Programmable Logic Device (CPLD) or a Field Programmable Gate Array (FPGA).

In the operation of data reception, the first buffer 31 buffers the receiving data Rx input from the PHY device 20 to be resynchronized in the unit of ten clocks, and delays the output time of the resynchronized receiving data Rx for a predetermined number of clocks.

In the operation of data transmission, the second buffer 32 buffers the transmitting data Tx input from the MAC device 10 to be resynchronized in the unit of ten clocks, and delays the output time of the resynchronized transmitting data Tx for a predetermined number of clocks.

In the operation of data transmission/reception, the third buffer 33 buffers the synchronization signals SYNCs input from the MAC device 10 every ten clocks to be resynchronized, and delays the output time of the resynchronized synchronization signals SYNCs for a predetermined number of clocks.

Since the number of times of the resynchronization process is set one to ten in consideration of the length of PCB pattern and so on, the respective bits of the transmitting/receiving data Tx/Rx are resynchronized as much as the time set and output in serial.

The clock phase selector 34 varies the phase of the system clock based on the changes of the input setup time and the input hold time caused by the physical arrangement of the devices, such as the MAC and PHY devices 10 and 20, and the patterns on PCB in the switching system. The system clock is supplied from a specific clock generating means, not depicted, or from the MAC device 10 in the system, based on the SMII standard.

In this embodiment, the system clocks varied by the clock phase selector 34 are supplied to the first to third buffers 31-33, whereas, the system clocks not varied by the clock phase selector 34 are provided to the MAC and PHY devices 10 and 20.

The clock phase selector 34 varies the phase of the system clock to 0, 90, 180 or 270 degree according to a user's operation of DIP switch, for example, not depicted. The variations of the phase, such as 0, 90, 180 and 270 degrees result in the system clocks delays of 0, 2, 4 and 6 ns, respectively.

The first to third buffers 31-33 resynchronizes the transmission data including the synchronization signal SYNC and the transmitting/receiving data Tx/Rx with the system clocks of which the phase is varied by the clock phase selector 34, thus positioning the respective bits of the transmitting/receiving data Tx/Rx on rising edges of the clocks. Accordingly, the transmission data of the respective bits are recognized accurately.

Meanwhile, a logic configuration of the clock phase selector 34 can be achieved through a following 1 or 2 VHDL algorithm (Very High Speed Integrated Circuit VHSIC+Hardware Description Language HDL):

1. VHDL applying “CLK DLL” of a general arbitration logic;

component CLK DLL

port(CLKIN, CLKFB, RST: in STD_LOGIC:

end component;

CLKIN<=CLKi; // CLKi denoting an input of the selector 34

If SEL=‘00’ then

CLKo<=CLK0; // 0 degree phase variation

Else if SEL=‘01’ then

CLKo<=CLK90; // 90 degree phase variation

Else if SEL=‘10’ then

CLKo<=CLK180; // 180 degree phase variation

Else if SEL=‘11’ then

CLKo<=CLK270; // 270 degree phase variation

2. VHDL not applying the “CLK DLL” of the general arbitration logic, wherein CLK1 to CLK4 denote input values of a reference file in the CPLD constructing the clock phase selector 34;

CLK1=OUT 0 ns AFTER CLKi; // 0 degree phase variation

CLK2=OUT 2 ns AFTER CLKi; // 90 degree phase variation

CLK3=OUT 4 ns AFTER CLKi; // 180 degree phase variation

CLK4=OUT 6 ns AFTER CLKi; // 270 degree phase variation

CLKIN<=CLKi; // CLKi denoting an input of the selector 34

If SEL=‘00’ then

CLKo<=CLK1;

Else if SEL=‘01’ then

CLKo<=CLK2;

Else if SEL=‘10’ then

CLKo<=CLK3;

Else if SEL=‘11’ then

CLKo<=CLK4;

The VHDL algorithm constructing the logic is changeable according to the program language applied to.

In the above configuration of FIG. 4, one clock phase selector 34 is connected to the first to third buffers 31-33 to supply the system clock of which the phase is varied in the same ratio to the buffers 31-33, whereas each of the clock phase selector 34 may be coupled to the first to third buffers 31-33, respectively, so as to provide the system clocks having difference phases with the first to third buffers 31-33. Besides, the clock phase selector 34 can be attached to the first to third buffers 31-33 selectively in consideration of the physical status of the system. Since the physical status of the system may vary the input setup time T1 and the input hold time T2 for accurately recognizing the transmission data.

The first to third clock switches 35-37 switch respective output paths of the first to third buffers 31-33 to delay the respective transmission data output from the first to third buffers 31-33 for 0 (zero) to n clocks. The output paths of the first to third buffers 31-33 include output ends A0-An, B0-Bn and C0-Cn, respectively, as shown in FIG. 4. The output ends A0-An, B0-Bn and C0-Cn are coupled to input ends of the first to third clock switches 35-37. An output end of the first clock switch 35 is linked to the MAC device 10 and output ends of the second and third clock switches 36 and 37 are connected to the PHY device 20 according to the SMII standard.

The delaying process of the respective transmission data for 0 to n clocks is to compensate the time delay between the synchronization signals SYNCs and the transmitting/receiving data Tx/Rx. The switching process of the first to third clock switches 35-37 is determined within 0 to n clocks by a user's operation of DIP switch.

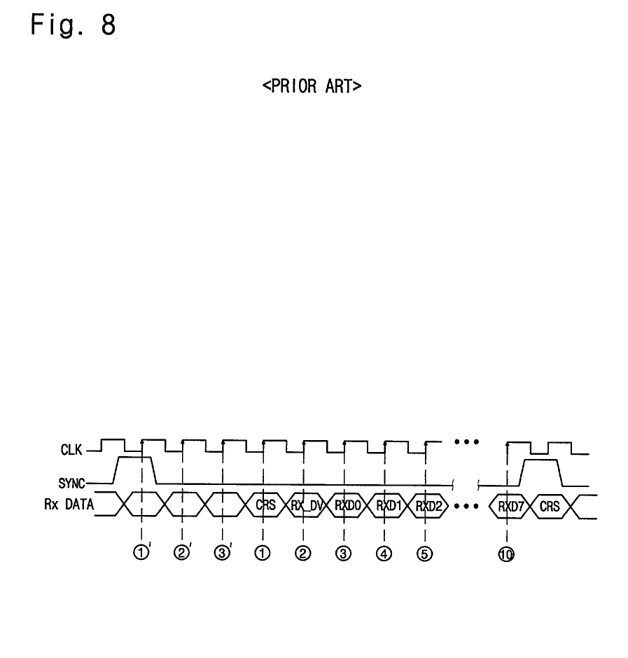

Here, referring to FIG. 8, it can be seen that the time delay between the synchronization signal SYNC and the receiving data Rx occurs for three clocks (\mathring{1}′-\mathring{3}′). That is, it can compensate the data transmission delay by delaying the respective receiving data Rx for three clocks against the synchronization signals SYNCs.

In the above configuration of FIG. 4, the operation selections of the clock phase selector 34 and the clock switches 35-37 are made by the DIP switches, whereas, it is possible to provide a separate processor for the same selection. Here, the processor is configured to control the operations of the clock phase selector 34 with an information table having phase variation ratios of the system clock in consideration of the physical status of the switching system, and the switching operations of the first to third clock switches 35-37 by checking the time delay between the synchronization signals SYNCs and the transmitting/receiving data Tx/Rx caused by the length of PCB pattern amongst the MAC and PHY devices 10 and 20.

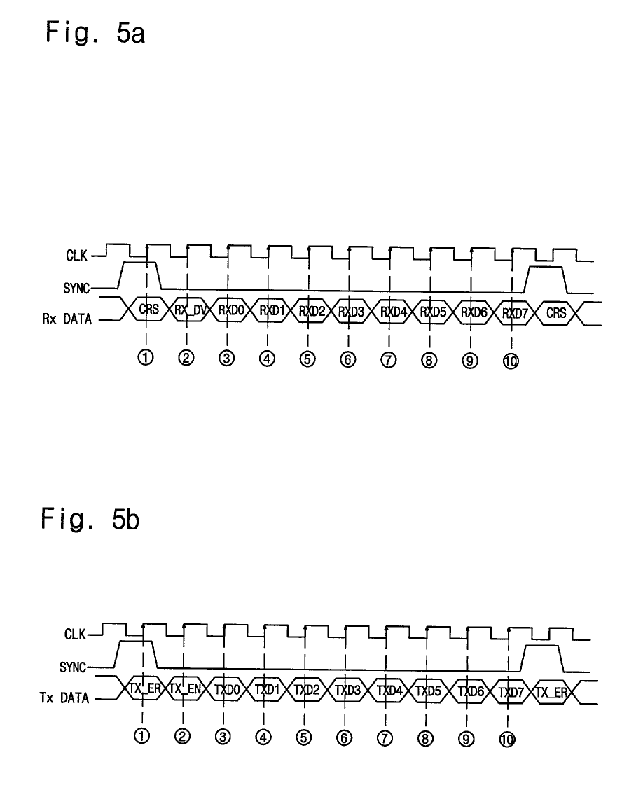

Hereinafter, operations of the apparatus 30 for arbitrating data transmission and a method therefor in accordance with another embodiment of the invention will be described with reference to FIGS. 5 to 7.

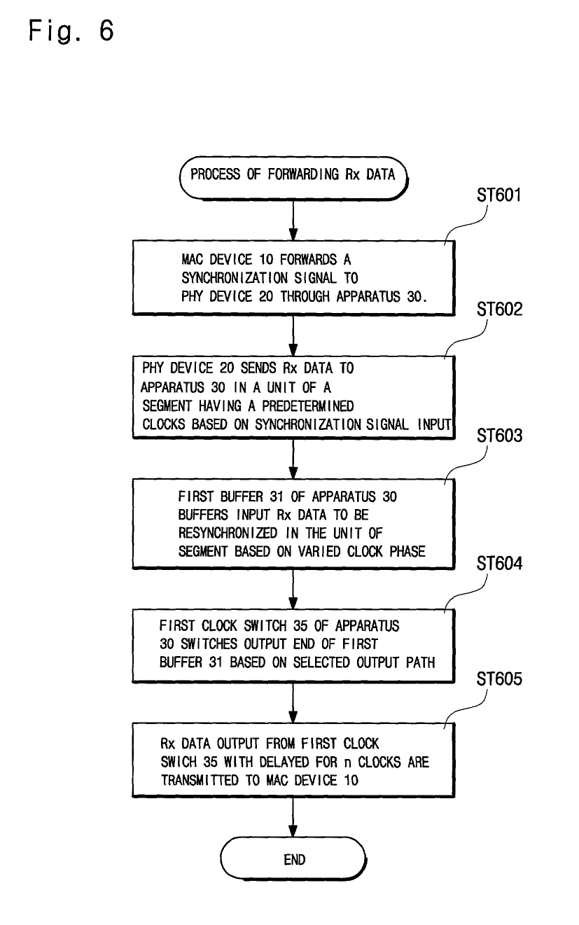

With reference to FIG. 6, steps of forwarding the receiving data Rx from the PHY device 20 to the MAC device 10 will be described hereinafter.

If the receiving data Rx from the external Ethernet is transmitted to the Ethernet switch, the MAC device 10 applies the synchronization signal SYNC in FIG. 5a to the third buffer 33 of the apparatus 30 in FIG. 4. Here, the system clocks CLKs varied according to the phase selected by the clock phase selector 34 are supplied to the third buffer 33. Then, the third buffer 33 buffers the synchronization signal SYNC to be resynchronized based on the varied phase of the system clock. The third clock switch 37 transmits the synchronization signal SYNC to the PHY device 20 by switching the output end of the third buffer 33 according to the output path previously selected by the DIP switch (Step 601).

The PHY device 20 receiving the synchronization signal SYNC from the apparatus 30 forwards the receiving data Rx in the unit of the segment having ten clocks (\mathring{1}-\mathring{10}) depicted in FIG. 5a based on the received synchronization signal SYNC to the first buffer 31 of the apparatus 30 in FIG. 4 (Step 602).

Next, the first buffer 31 buffers the receiving data Rx to be resynchronized once to ten times according to the system clocks CLKs varied based on the phase selected by the clock phase selector 34. Accordingly, the receiving data Rx are delayed based on the varied system clock (Step 603).

If the first clock switch 35 switches the output ends (A0-An) of the first buffer 31 based on the output path previously selected by the DIP switch, the receiving data Rx of one segment are output through the switched output end and the selected output path (Step 604).

Here, according as the first clock switch 35 delivers the receiving data Rx delayed by the first buffer 31 for 0 to n clocks to the MAC device 10, the receiving data Rx from the Ethernet can be transmitted from the PHY device 20 to the MAC device 10 without any error (Step 605).

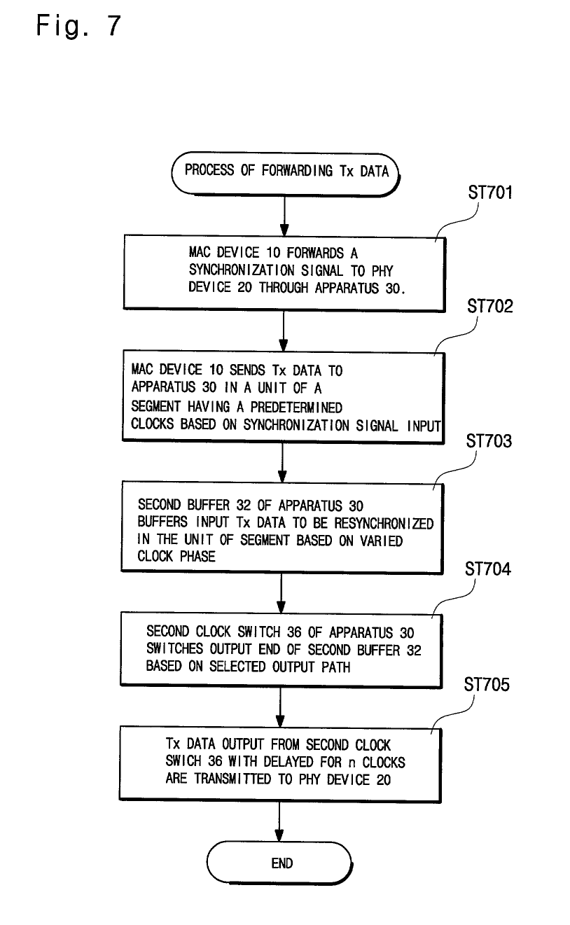

Hereinafter, with reference to FIG. 7, steps of supplying the transmitting data Tx from the MAC device 10 to the PHY devices 20 will be described.

If the transmitting data Tx to be sent to the external Ethernet is supplied to the Ethernet switch, the MAC device 10 applies the synchronization signal SYNC in FIG. 5b to the third buffer 33 of the apparatus 30 in FIG. 4. Here, the system clocks CLKs varied according to the phase selected by the clock phase selector 34 are supplied to the third buffer 33. Then, the third buffer 33 buffers the synchronization signal SYNC to be resynchronized based on the varied phase of the system clock. The third clock switch 37 transmits the synchronization signal SYNC to the PHY device 20 by switching the output end of the third buffer 33 according to the output path previously selected by the DIP switch (Step 701).

The MAC device 10 supplying the synchronization signal SYNC to the PHY device 10 forwards the transmitting data Tx in the unit of the segment having ten clocks (\mathring{1}-\mathring{10}) depicted in FIG. 5b based on the received synchronization signal SYNC to the second buffer 32 of the apparatus 30 in FIG. 4 (Step 702).

Next, the second buffer 32 buffers the transmitting data Tx to be resynchronized once to ten times according to the system clocks CLKs varied based on the phase selected by the clock phase selector 34. Accordingly, the transmitting data Tx are delayed based on the varied system clock (Step 703).

If the second clock switch 36 switches the output ends (B0-Bn) of the second buffer 32 based on the output path previously selected by the DIP switch, the transmitting data Tx of one segment are output through the switched output end and the selected output path (Step 704).

Here, according as the second clock switch 36 delivers the transmitting data Tx delayed by the second buffer 32 for 0 to n clocks to the PHY device 20, the transmitting data Tx from the Ethernet can be transmitted from the MAC device 10 to the PHY device 20 without any errors (Step 705).

According to the preferred embodiment of the invention described above, since the apparatus 30 for arbitrating data transmission amongst devices applied to an Ethernet switching system buffers the transmitting/receiving data Tx/Rx to be resynchronized in the unit of one segment having a predetermined number of clocks, it doesn't cause an errors in transmitting data of the respective clocks, but delays the arrival time of all transmission data of one segment, thus removing the restriction of the distance of PCB pattern between the MAC and PHY devices having the SMII standard.

Besides, according to the invention, since the buffers 31-33 resynchronizes the transmission data including the synchronization signal SYNC and the transmitting/receiving data Tx/Rx once to ten times according to the system clocks CLKs varied based on the phase selected by the clock phase selector 34, it can prevent the data transmission error.

Moreover, according to the invention, if there is a time delay between the synchronization signals SYNCs and the transmitting/receiving data Tx/Rx, the first to third clock switches 35-37 select the output paths for delaying the transmitting/receiving data Tx/Rx for 0 to n clocks against the synchronization signal SYNCs, thus compensating the data transmission delay.

It will be apparent to those skilled in the art that various modifications and variations can be made in the electrical connector of the present invention without departing from the spirit or scope of the invention. Thus, it is intended that the present invention cover the modifications and variations of this invention provided they come within the scope of the appended claims and their equivalents.

What is claimed is:

1. In an apparatus for arbitrating data transmission between a first and second devices corresponding to a media access control (MAC) device and a physical layer (PHY) device having a serial media independent interface (SMII), respectively,
the apparatus comprising:
at least one buffering means for buffering transmission data input from the first device to be resynchronized a predetermined number of times in a unit of a segment and outputting the resynchronized transmission data to the second device.

2. The apparatus for arbitrating data transmission amongst devices having SMII standard as recited in claim 1,
the apparatus further comprising at least one clock phase selecting means, connected to a clock input end of the buffering means, for varying phases of clocks input in predetermined ratios and supplying the varied clocks to the clock input end.

3. The apparatus for arbitrating data transmission amongst devices having SMII standard as recited in claim 1,
the apparatus further comprising at least one switching means, positioned between output ends of the buffering means and the second device, for switching output paths of the buffering means and sending the transmission data, output from the output end of the buffering means with delayed for a predetermined number of clocks, to the second device.

4. The apparatus for arbitrating data transmission amongst devices having SMII standard as recited in claim 2,
the apparatus further comprising at least one switching means, positioned between output ends of the buffering means and the second device, for switching output paths of the buffering means and sending the transmission data, output from the output end of the buffering means with delayed for a predetermined number of clocks, to the second device.

5. In an apparatus for arbitrating data transmission between a media access control (MAC) device and a physical layer (PHY) device having a serial media independent interface (SMII),
the apparatus comprising:
a first buffer for buffering receiving data, input from the PHY device in a unit of a segment, to be resynchronized a predetermined number of times and outputting the resynchronized receiving data to the MAC device;
a second buffer for buffering transmitting data, input from the MAC device in a unit of a segment, to be resynchronized a predetermined number of times and outputting the resynchronized transmitting data to the PHY device; and
a third buffer for buffering synchronization signals, input from the MAC device every segment, to be resynchronized a predetermined number of times and outputting the resynchronized synchronization signals to the PHY device.

6. The apparatus for arbitrating data transmission amongst devices having SMII standard as recited in claim 5,
wherein the first to third buffers include a plurality of output ends for outputting transmitting/receiving data and synchronization signals, respectively, with delayed for a predetermined number of clocks,
the apparatus further comprising;
a first clock switch for switching output paths of the first buffer and forwarding receiving data, output from the output end of the first buffer, to the MAC device;
a second clock switch for switching output paths of the second buffer and forwarding transmitting data, output from the output end of the second buffer, to the PHY device; and
a third clock switch for switching output paths of the third buffer and forwarding synchronization signals, output from the output end of the third buffer, to the PHY device.

7. The apparatus for arbitrating data transmission amongst devices having SMII standard as recited in claim 5,
the apparatus further comprising at least one clock phase selector, connected to each clock input end of the first to third buffers selectively, for varying phases of clocks input in predetermined ratios and supplying the varied clocks to the clock input end.

8. The apparatus for arbitrating data transmission amongst devices having SMII standard as recited in claim 6,
the apparatus further comprising at least one clock phase selector, connected to each clock input end of the first to third buffers selectively, for varying phases of clocks input in predetermined ratios and supplying the varied clocks to the clock input end.

9. The apparatus for arbitrating data transmission amongst devices having SMII standard as recited in claim 7,
wherein the number of times for resynchronizing process is set one to ten.

10. The apparatus for arbitrating data transmission amongst devices having SMII standard as recited in claim 7,
wherein the operations of selecting the clock phase by means of the clock phase selector, and switching the output paths of the first to third buffers by means of the first to third clock switches, are executed by at least one DIP switch.

11. The apparatus for arbitrating data transmission amongst devices having SMII standard as recited in claim 7,
wherein the operations of selecting the clock phase by means of the clock phase selector, and switching the output paths of the first to third buffers by means of the first to third clock switches, are executed by a control means including a storing means storing a predetermined phase information of the clock varied based on a physical status of a system, the control means figuring out how much delays occur between the transmitting/receiving data and the synchronization signals.

12. In a method for arbitrating data transmission between a first and a second devices corresponding to a media access control (MAC) device and a physical layer (PHY) device having a serial media independent interface (SMII), respectively,
the method comprising:
buffering transmission data input from the first device to be resynchronized a predetermined number of times in a unit of a segment having a predetermined number of clocks;
switching output paths to output the buffered transmission data with delayed for a predetermined number of clocks; and
forwarding the delayed transmission data to the second device.

13. The method for arbitrating data transmission amongst devices having SMII standard as recited in claim 12,
wherein the transmission data includes transmitting, receiving data and synchronization signals, and
wherein the number of times for resynchronizing process is set one to ten.
